(19) United States
(12) Patent Application Publication
(10) Pub. No.: US 2017/0279566 A1
(43) Pub. Date: Sep. 28, 2017

(54) CARRIER AGGREGATION DEVICE

(71) Applicant: ZHONGXING MICROELECTRONICS TECHNOLOGY CO.LTD, Shenzhen, Guangdong (CN)

(72) Inventor: Haiguang Liu, Shenzhen (CN)

(21) Appl. No.: 15/504,113

(22) PCT Filed: Dec. 8, 2014
(86) PCT No.: PCT/CN2014/093225

§ 371 Date: Mar. 16, 2017

(30) Foreign Application Priority Data
Aug. 15, 2014 (CN) 201410404889.X

(51) Int. Cl. H04L 5/00; H04L 5/14

(52) U.S. Cl. CPC H04L 5/001; H04L 5/14

(57) ABSTRACT

Disclosed is a carrier aggregation device. The device comprises: a first transceiver antenna, a second transceiver antenna, a first radio frequency front end, a second radio frequency front end, and a radio frequency transceiver chip. A signal received by the first transceiver antenna is divided into a high frequency signal, an intermediate frequency signal and a low frequency signal through the first radio frequency front end, and the three signals separately enter the radio frequency transceiver chip. A signal received by the second transceiver antenna is divided into high frequency signal, an intermediate frequency signal and a low frequency signal through the second radio frequency front end, and the three signals separately enter the radio frequency transceiver chip.

### TECHNICAL FIELD

The disclosure relates to the field of multimode mobile communications, and in particular to a carrier aggregation device.

### BACKGROUND

Along with the arrival of the fourth generation of the mobile communications technology (4G), in order to support higher rate, the 3rd generation partnership project (3GPP) proposes a senior long-term evolution advance (LTE-A), which is capable of supporting more bandwidth combinations, realizing resource integration, improving the data service rate, and the data rate is significantly improved through carrier aggregation particularly when the frequency band resource is limited. Currently existed terminal carrier aggregation technology is commonly the combination of a low frequency band and a high frequency band, which is capable of realizing continuous carrier aggregation (Intra-CA) in band, the current carrier aggregation solution for a low, an intermediate and a high frequency band is based on a 4-antenna architecture, but the 4-antenna carrier aggregation is almost not realizable for a terminal.

### SUMMARY

In view of the above, embodiments of the disclosure are intended to provide a carrier aggregation device.

An embodiment of the disclosure provides a carrier aggregation device, the device includes: a first transceiver antenna, a second transceiver antenna, a first radio-frequency front end, a second radio-frequency front end and a radio-frequency transceiver chip; wherein,
a signal received by the first transceiver antenna is split into a high frequency signal, an intermediate frequency signal and a low frequency signal through the first radio-frequency front end, and the three signals separately enter the radio-frequency transceiver chip; and
a signal received by the second transceiver antenna is split into a high frequency signal, an intermediate frequency signal and a low frequency signal through the second radio-frequency front end, and the three signals separately enter the radio-frequency transceiver chip.

In above solution, the first radio-frequency front end includes: a first duplexer, the first transceiver antenna is connected to the first duplexer; the first duplexer is arranged to split the signal, received from the first transceiver antenna, into a first signal including a low frequency signal and a second signal including an intermediate frequency signal and a high frequency signal; and
the second frequency front end includes: a second duplexer, the second transceiver antenna is connected to the second duplexer; the second duplexer is arranged to split the signal, received from the second transceiver antenna, into a third signal including a low frequency signal and a fourth signal including an intermediate frequency signal and a high frequency signal.

In above solution, the first radio-frequency front end further includes: a first energy diversity device and a first antenna switch; a low frequency output end of the first duplexer is connected to a low frequency receiving port of the first antenna switch; an intermediate and a high frequency output ends of the first duplexer are connected to the first antenna switch through the first energy diversity device; wherein, the first energy diversity device is arranged to receive the second signal sent by the first duplexer, execute frequency division processing on the second signal and send the two signals to the first antenna switch after frequency division processing; and
the second radio-frequency front end further includes: a second energy diversity device and a second antenna switch; a low frequency output end of the second duplexer is connected to a low frequency receiving port of the second antenna switch; an intermediate and a high frequency output ends of the second duplexer are connected to the second antenna switch through the second energy diversity device; wherein, the second energy diversity device is arranged to receive the fourth signal sent by the second duplexer, execute frequency division processing on the fourth signal and send the two signals to the second antenna switch after frequency division processing.

In above solution, the first energy diversity device is arranged to split the received second signal into a fifth signal including an intermediate frequency and a sixth signal including a high frequency; the second energy diversity device is arranged to split the received fourth signal into a seventh signal including an intermediate frequency and an eighth signal including a high frequency.

In above solution, a high frequency output end of the first energy diversity device is connected to a high frequency receiving port of the first antenna switch; and an intermediate frequency output end of the first energy diversity device is connected to an intermediate frequency receiving port of the first antenna switch; and
a high frequency output end of the second energy diversity device is connected to a high frequency receiving port of the second antenna switch; and an intermediate frequency output end of the second energy diversity device is connected to an intermediate frequency receiving port of the second antenna switch.

In above solution, the first energy diversity device is a diplexer or a low noise amplifier (LNA); and the second energy diversity device is a diplexer or a LNA.

In above solution, the first radio-frequency front end further includes: a first filter, a second filter and a third filter;
the first signal is sent to the first antenna switch, the first filter and then output to the radio-frequency transceiver chip after the clutter is filtered;
the fifth signal is sent to the first antenna switch, the second filter and then output to the radio-frequency transceiver chip after the clutter is filtered;
the sixth signal is sent to the first antenna switch, the third filter and then output to the radio-frequency transceiver chip after the clutter is filtered;
the second radio-frequency front end further includes: a fourth filter, a fifth filter and a sixth filter;
the third signal is sent to the second antenna switch, the fourth filter and then output to the radio-frequency transceiver chip after the clutter is filtered;
the seventh signal is sent to the second antenna switch, the fifth filter and then output to the radio-frequency transceiver chip after the clutter is filtered; and
the eighth signal is sent to the second antenna switch, the sixth filter and then output to the radio-frequency transceiver chip after the clutter is filtered.

According to the embodiments of the disclosure, a carrier aggregation device is provided, including: a first transceiver antenna, a second transceiver antenna, a first radio-frequency front end, a second radio-frequency front end and a radio-frequency transceiver chip; wherein, a signal received by the first transceiver antenna is split into a high frequency signal, an intermediate frequency signal and a low frequency signal through the first radio-frequency front end, and the three signals separately enter the radio-frequency transceiver chip; and a signal received by the second transceiver antenna is split into a high frequency signal, an intermediate frequency signal and a low frequency signal through the second radio-frequency front end, and the three signals separately enter the radio-frequency transceiver chip. Therefore, a double-antenna carrier aggregation device can be achieved. Compared with the related art, two antennas are omitted, the layout area of a printed circuit board (PCB) is reduced while the interference is reduced, and accordingly, the product manufacturing cost is greatly reduced.

### BRIEF DESCRIPTION OF THE DRAWINGS

FIG. 1 is a basic structural diagram of a carrier aggregation device in the related art;

FIG. 2 is a basic structural diagram 1 of a carrier aggregation device of the disclosure;

FIG. 3 is a basic structural diagram 2 of a carrier aggregation device of the disclosure;

FIG. 4 is a basic structural diagram 3 of a carrier aggregation device of the disclosure.

### DETAILED DESCRIPTION

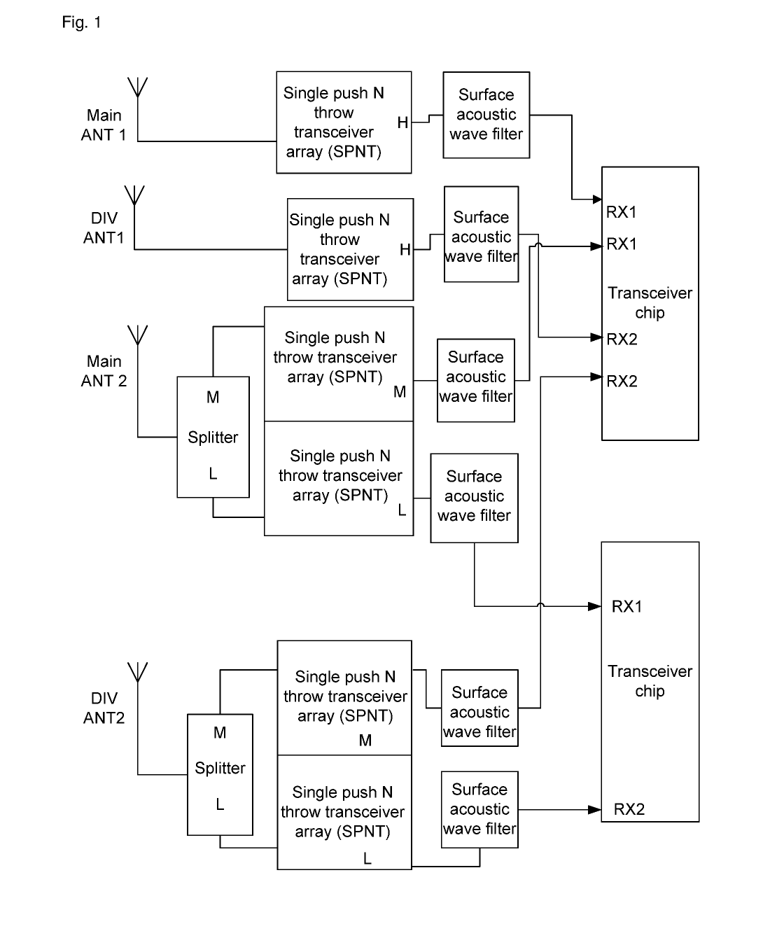

In a traditional carrier aggregation device covering low, intermediate and high frequencies, the radio-frequency front end includes fourth antennas for achieving main reception and diversity reception of a main-auxiliary carrier in carrier aggregation respectively. FIG. 1 is a basic structural diagram of a traditional four-antenna carrier aggregation device. The structure of the traditional carrier aggregation device is described below with reference to FIG. 1.

A signal enters a carrier aggregation device through a transceiver antenna port (Main ANT1 and DIV ANT1), then enters a radio-frequency transceiver chip through a radio-frequency front end (including a front-stage radio-frequency antenna switch, a filter etc.). For example, the front-stage radio-frequency antenna switch in FIG. 1 uses a single push N throw (SPNT) transceiver array, the filter uses a surface acoustic wave filter (SAWF), the Main ANT1 and the DIV ANT1 are mainly used in main and diversity reception of a high frequency band respectively. Then, a signal output by the transceiver chip, after digital processing such as analog/digital (A/D) conversion etc., is output to a baseband chip. Thereby, the receiving and processing of the high frequency band radio-frequency signal are achieved.

Similarly, a signal enters a carrier aggregation device through antenna ports (MAIN ANT2 and DIV ANT2), the signal is split into low and intermediate frequency signals through low and intermediate frequency diplexers, and the two signals enter two radio-frequency transceivers respectively through radio-frequency front ends (including a front-end radio-frequency antenna switch, a filter etc.). For example, the front-end radio-frequency antenna switch in FIG. 1 uses a SPNT transceiver array, the filter uses a SAW filter, the MAIN ANT2 and the DIV ANT2 are mainly used in main and diversity reception of low and intermediate frequencies, respectively. A signal output by the transceiver, after digital processing such as A/D conversion etc., is output to the baseband chip, and thereby the receiving and processing of the low and intermediate frequency band radio-frequency signals are achieved.

In an embodiment of the disclosure, a carrier aggregation device is provided, the device includes: a first transceiver antenna, a second transceiver antenna, a first radio-frequency front end, a second radio-frequency front end and a radio-frequency transceiver chip.

A signal received by the first transceiver antenna is split into a high frequency signal, an intermediate frequency signal and a low frequency signal through the first radio-frequency front end, and the three signals separately enter the radio-frequency transceiver chip; a signal received by the second transceiver antenna is split into a high frequency signal, an intermediate frequency signal and a low frequency signal through the second radio-frequency front end, and the three signals separately enter the radio-frequency transceiver chip.

The disclosure is further described below with reference to drawings and embodiments.

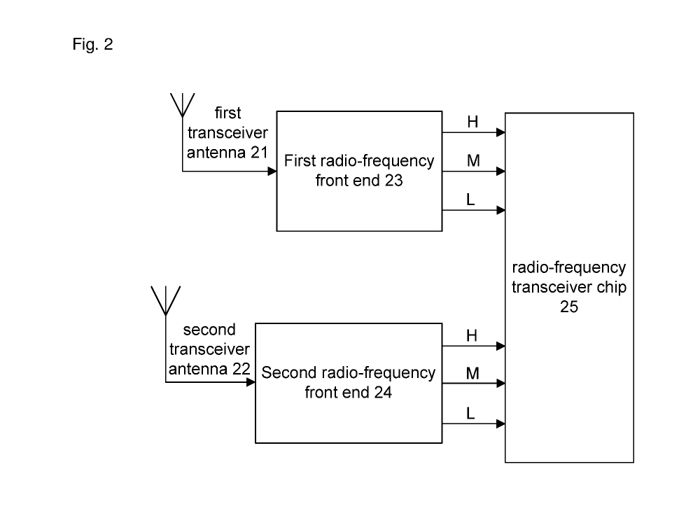

The first embodiment of the disclosure provides a carrier aggregation device, as shown in FIG. 2. The device includes: a first transceiver antenna 21, a second transceiver antenna 22, a first radio-frequency front end 23, a second radio-frequency front end 24 and a radio-frequency transceiver chip 25; wherein, a signal received by the first transceiver antenna 21 is split into a high frequency signal (the signal labeled as H in the figure), an intermediate frequency signal ((the signal labeled as M in the figure) and a low frequency signal ((the signal labeled as L in the figure) through the first radio-frequency front end 23, and the three signals separately enter the radio-frequency transceiver chi 25; a signal received by the second transceiver antenna 22 is split into a high frequency signal ((the signal labeled as H in the figure), an intermediate frequency signal ((the signal labeled as M in the figure) and a low frequency signal (signal marked with L in the figure) through the second radio-frequency front end 24, and the three signals separately enter the radio-frequency transceiver chip.

The first radio-frequency front end 23 includes a first duplexer connected to the first transceiver antenna 21. The first duplexer is arranged to split the signal, received from the first transceiver antenna 21, into a first signal including the low frequency signal and a second signal including the intermediate frequency signal and the high frequency signal.

The second frequency front end 24 includes a second duplexer connected to the second transceiver antenna 22; the second duplexer is arranged to split the signal, received from the second transceiver antenna 22, into a third signal including the low frequency signal and a fourth signal including the intermediate frequency signal and the high frequency signal.

The first radio-frequency front end 23 may further include: a first energy diversity device and a first antenna switch. A low frequency output end of the first duplexer is connected to a low frequency receiving port of the first antenna switch; intermediate and high frequency output ends of the first duplexer are connected to the first antenna switch through the first energy diversity device; the first energy diversity device is arranged to receive the second signal sent by the first duplexer, execute frequency division processing on the second signal and send two signals obtained after the frequency division processing on the second signal to the first antenna switch.

The second radio-frequency front end 24 may further includes a second energy diversity device and a second antenna switch. A low frequency output end of the second duplexer is connected to a low frequency receiving port of the second antenna switch; intermediate and high frequency output ends of the second duplexer are connected to the second antenna switch through the second energy diversity device; the second energy diversity device is arranged to receive the fourth signal sent by the second duplexer, execute frequency division processing on the fourth signal and send two signals obtained after the frequency division processing on the fourth signal to the second antenna switch.

The first energy diversity device may be arranged to split the received second signal into a fifth signal including an intermediate frequency and a sixth signal including a high frequency; and the second energy diversity device is arranged to split the received fourth signal into a seventh signal including an intermediate frequency and an eighth signal including a high frequency.

A high frequency output end of the first energy diversity device may be connected to a high frequency receiving port of the first antenna switch; and an intermediate frequency output end of the first energy diversity device may be connected to an intermediate frequency receiving port of the first antenna switch.

A high frequency output end of the second energy diversity device may be connected to a high frequency receiving port of the second antenna switch; and an intermediate frequency output end of the second energy diversity device may be connected to an intermediate frequency receiving port of the second antenna switch.

The first energy diversity device may be a diplexer or a low noise amplifier (LNA); and the second energy diversity device may be a diplexer or a LNA.

The first radio-frequency front port May further include: a first filter, a second filter and a third filter.

The first signal, after passing through the first antenna switch, passes through the first filter for clutter filtering and then is output to the radio-frequency transceiver chip.

The fifth signal, after passing through the first antenna switch, passes through the second filter for clutter filtering and then is output to the radio-frequency transceiver chip.

The sixth signal, after passing through the first antenna switch, passes through the third filter for clutter filtering and then is output to the radio-frequency transceiver chip.

The second radio-frequency front port May further include: a fourth filter, a fifth filter and a sixth filter.

The third signal, after passing through the second antenna switch, passes through the fourth filter for clutter filtering and then is output to the radio-frequency transceiver chip.

The seventh signal, after passing through the second antenna switch, passes through the fifth filter for clutter filtering and then is output to the radio-frequency transceiver chip.

The eighth signal, after passing through the second antenna switch, passes through the sixth filter for clutter filtering and then is output to the radio-frequency transceiver chip.

Those skilled in the art can understand that actually the first filter, the second filter, the third filter, the fourth filter, the fifth filter and the sixth filter may be integrated in a filter, or are at two, three, four, five filters as desired.

The carrier aggregation device of the disclosure is further described below with reference to two embodiments.

### Embodiment 1

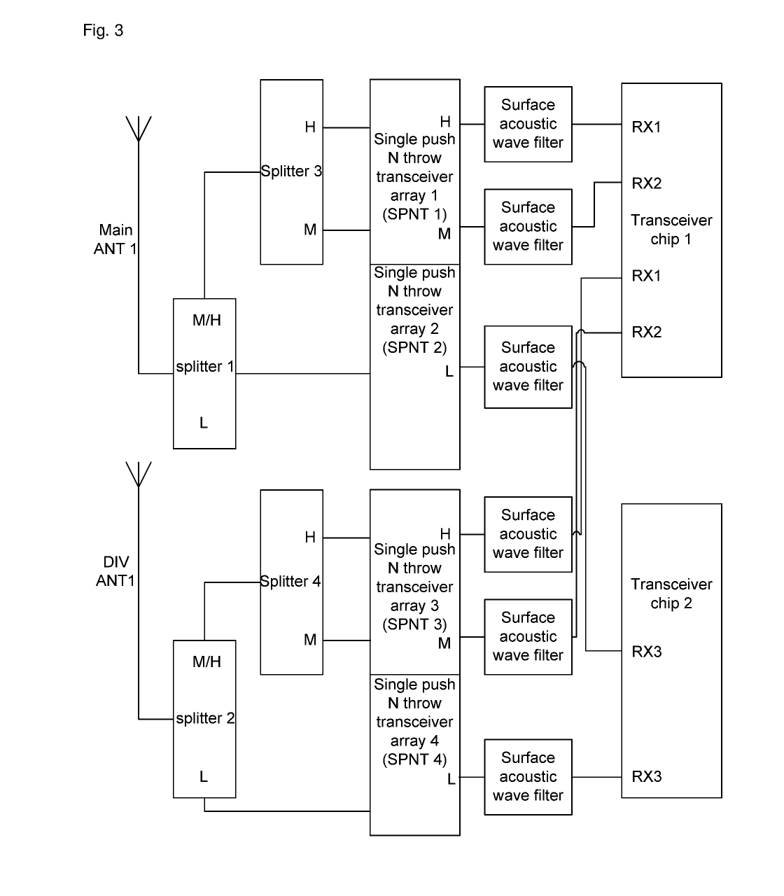

FIG. 3 is a structural diagram of a carrier aggregation device of the disclosure. As shown in FIG. 3, a signal enters a carrier aggregation device through transceiver antennas (Main ANT and DIV ANT), then enters a radio-frequency transceiver chip through a radio-frequency front end; the radio-frequency front end includes a diplexer, an antenna switch and a filter. For example, the front-end radio-frequency antenna switch in FIG. 3 uses a SPNT transceiver array, the filter uses a SAW filter, the Main ANT and the DIV ANT achieve main and diversity reception respectively of a high frequency band, an intermediate frequency band and a low frequency band. As shown in FIG. 3, a signal, after entering the Main ANT, is split into a low frequency signal, and an intermediate and high frequency mixed signal through a diplexer 1. The low frequency signal is directly connected to a low frequency signal receiving port (port L) of a SPNT2. The intermediate and high frequency mixed signal is split into a high frequency signal and a low frequency signal through a diplexer 3. Then, the two signals are connected to a high frequency receiving port (port H) and a low frequency receiving port (port M) of a SPNT 1 respectively. Thus, the signal passing through the Main ANT is finally split into three signals (a low frequency signal, an intermediate frequency signal and a high frequency signal), the three signals, after clutter filtering process by the filter, enter a high frequency receiving port (Rx1), an intermediate frequency receiving port (Rx2) of the transceiver 1 and a low frequency receiving port (Rx3) of the transceiver 2 respectively.

Similarly, a signal, after entering the DIV ANT, is split into a low frequency signal, and an intermediate and high frequency mixed signal through the diplexer 2. The low frequency signal is directly connected to a low frequency signal receiving port (port L) of a SPNT4. The intermediate and high frequency mixed signal is split into a high frequency signal and a low frequency signal through the diplexer 3. Then the two signals are connected to a high frequency receiving port (port H) and a low frequency receiving port (port M) of the SPNT 3 respectively. Thus, the signal, passing through the Main ANT, is finally split into three signals (a low frequency signal, an intermediate frequency signal and a high frequency signal). The three signals, after clutter filtering process by the filter, enter a high frequency receiving port (Rx1), an intermediate frequency receiving port (Rx2) of the transceiver 1 and a low frequency receiving port (Rx3) of the transceiver 2 respectively.

In the embodiment, the diplexer 3 and the diplexer 4 have characteristics of single-input and double-output of intermediate and high frequency signals, for the purpose of dividing an intermediate and high frequency signal into two signals which enter two receiving channels respectively, to ensure that the intermediate and high frequency bands are multiplexed in one channel to implement the carrier aggregation function of low, intermediate and high frequency bands. Compared with the related art, the solution of the disclosure omits two antennas and two antenna switches.

### Embodiment 2

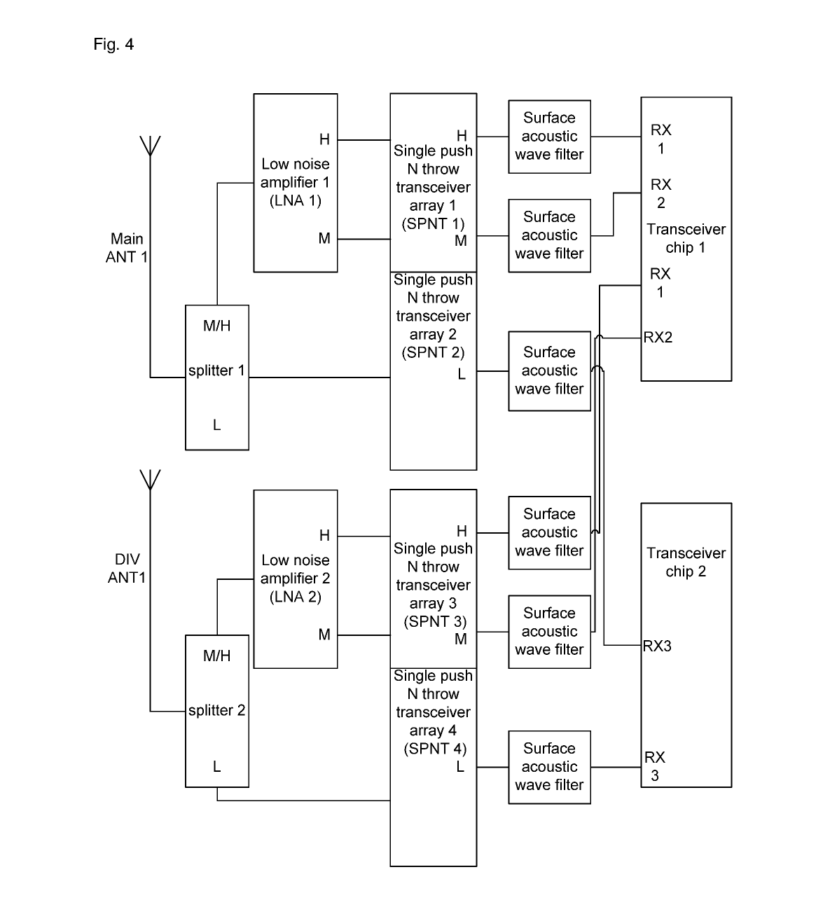

FIG. 4 is another structural diagram of a carrier aggregation device of the disclosure. Compared with FIG. 3, in FIG. 4, the diplexer 3 and the diplexer 4 are replaced by a LNA 1 and a LNA 2, while the other parts are the same and thus use the same reference signs as those in FIG. 3.

A signal enters a carrier aggregation device through transceiver antennas (Main

ANT and DIV ANT), and then enters a radio-frequency transceiver chip through a radio-frequency front end. The radio-frequency front end includes a diplexer, an antenna switch and a filter. As shown in FIG. 4, a signal, after entering through the Main ANT, is split into a low frequency signal, and an intermediate and high frequency mixed signal through a diplexer 1. The low frequency signal is directly connected to a low frequency signal receiving port (port L) of a SPNT2. The intermediate and high frequency mixed signal is split into a high frequency signal and a low frequency signal through the LNA 1. Then, the two signals are connected to a high frequency receiving port (port H) and a low frequency receiving port (port M) of a SPNT 1 respectively. Thus, the signal, passing through the Main ANT, is finally split into three signals (a low frequency signal, an intermediate frequency signal and a high frequency signal). The three signals, after clutter filtering process by the filter, enter a high frequency receiving port (Rx1), an intermediate frequency receiving port (Rx2) of the transceiver 1 and a low frequency receiving port (Rx3) of the transceiver 2 respectively.

Similarly, a signal, after entering the DIV ANT, is split into a low frequency signal, and an intermediate and high frequency mixed signal through the diplexer 2. The low frequency signal is directly connected to a low frequency signal receiving port (port L) of a SPNT4. The intermediate and high frequency mixed signal is split into a high frequency signal and a low frequency signal through the LNA 2. Then, the two signals are connected to a high frequency receiving port (port H) and a low frequency receiving port (port M) of the SPNT 3 respectively. Thus, the signal, passing through the Main ANT, is finally split into three signals (a low frequency signal, an intermediate frequency signal and a high frequency signal). The three signals, after clutter filtering process by the filter, enter a high frequency receiving port (Rx1), an intermediate frequency receiving port (Rx2) of the transceiver 1 and a low frequency receiving port (Rx3) of the transceiver 2 respectively.

In the embodiment, the LNA 1 and the LNA 2 are LNAs having a characteristic of double-output, for the purpose of dividing an intermediate and high frequency signal into two signals which enter two receiving channels respectively, to ensure that the intermediate and high frequency bands are multiplexed in one channel to implement the carrier aggregation function of low, intermediate and high frequency bands. Compared with the related art, the solution of the disclosure omits two antennas and two antenna switches.

It is to be noted that, although the embodiment 1 and the embodiment 2 use four SPNT transceiver arrays as transceiver antennas, the number of the SPNT is not limited in practical application, which can be one or multiple, as long as there are two low frequency signal receiving ports, two intermediate frequency signal receiving ports and two high frequency signal receiving ports. Similarly, the number of the radio-frequency transceiver chip is not limited, as long as there are a corresponding number and corresponding function of receiving ports.

The above are only the preferred embodiments of the disclosure, and not intend to limit the scope of protection of the disclosure.

1. An encrypted communication method, comprising:
reading, by a source communication terminal, an encryption algorithm and an index of the encryption algorithm from a first Near Field Communication (NFC) security label card;
encrypting, by the source communication terminal, a data packet to be transmitted with the encryption algorithm to generate an encrypted data packet;
sending, by the source communication terminal the encrypted data packet to a target communication terminal; and
sending, by the source communication terminal, the index to the target communication terminal;
wherein the index is used by the target communication terminal to obtain the encryption algorithm to decrypt the encrypted data packet.

2. The method according to claim 1, wherein
the encrypted data packet comprises an encrypted part and an unencrypted part;
the index is carried in the unencrypted part;
sending the index comprises:
carrying the index in the encrypted data packet to be sent along with the data packet.

3. The method according to claim 2, further comprising:
adding an encryption label to the unencrypted part;
wherein the encryption label is arranged to indicate that the data packet where the label locates is the encrypted data packet.

4. (canceled)

5. The method according to claim 1, wherein
sending the index comprises:
sending the index through a negotiation data packet;
the negotiation data packet is a data packet which is used by the source communication terminal to send the index to the target communication terminal.

6. The method according to claim 5, wherein
sending the negotiation data packet to the target communication terminal through a short message communication link or a voice communication link when the source communication terminal performs voice communication with the target communication terminal.

7. (canceled)

8. (canceled)

9. An encrypted communication method, comprising:
receiving, by a target communication terminal, an index of an encryption algorithm from a source communication terminal;
receiving, by the target communication terminal, an encrypted data packet from a source communication terminal;
retrieving, by the target communication terminal, a decryption algorithm from a second Near Field Communication (NFC) security label card according to the index; and
decrypting, by the target communication terminal, the encrypted data packet according to the decryption algorithm to obtain the decrypted data packet.

10. The method according to claim 9, wherein
the encrypted data packet comprises an encrypted part and an unencrypted part;
the index is carried in the encrypted data packet to be received along with the encrypted data packet.

11. The method according to claim 10, wherein
the unencrypted part also comprises an encryption label;
the method further comprises:
parsing the unencrypted part of the received data packet to determine whether the encrypted data packet comprises the encryption label; and
determining, when the encrypted data packet comprises the encryption label, that the data packet is the encrypted data packet, and proceeding to the step of retrieving the decryption algorithm from the second NFC security label card according to the index.

12. (canceled)

13. The method according to claim 9, wherein
receiving the index of the encryption algorithm comprises:
receiving a negotiation data packet;
wherein the negotiation data packet is a data packet which is used by the source communication terminal to send the index to the target communication terminal.

14. The method according to claim 13, wherein
when the source communication terminal performs voice communication with the target communication terminal, receiving the negotiation data packet comprises: receiving the negotiation data packet through a short message communication link or a voice communication link.

15. (canceled)

16. (canceled)

17. A source communication terminal, comprising:
a reading unit arranged to read an encryption algorithm and an index of the encryption algorithm from a first Near Field Communication (NFC) security label card;
an encrypting unit arranged to encrypt a data packet to be transmitted with the encryption algorithm to generate an encrypted data packet;
a sending unit arranged to send the encrypted data packet to a target communication terminal; and
the sending unit is further arranged to send the index to the target communication terminal;
wherein the index is used by the target communication terminal to obtain the encryption algorithm to decrypt the encrypted data packet.

18. The terminal according to claim 17, wherein
the encrypted data packet comprises an encrypted part and an unencrypted part; the index is carried in the unencrypted part;
the sending unit is arranged to carry the index in the encrypted data packet to send the index along with the data packet.

19. The terminal according to claim 18, further comprising:
an adding unit arranged to add an encryption label to the unencrypted part;
wherein the encryption label is used to indicate that the data packet where the label locates is the encrypted data packet.

20. (canceled)

21. The terminal according to claim 17, wherein
the sending unit is arranged to send the index through a negotiation data packet;
the negotiation data packet is a data packet which is used by a source communication terminal to send the index to a target communication terminal.

22. The terminal according to claim 21, wherein
the sending unit is arranged to send, when the source communication terminal performs voice communication with the target communication terminal, the negotiation data packet to the target communication terminal through a short message communication link or a voice communication link.

23. (canceled)

24. (canceled)

25. A target communication terminal, comprising:
a receiving unit arranged to receive an index of an encryption algorithm from a source communication terminal; the receiving unit is further arranged to receive an encrypted data packet from the source communication terminal;
a retrieving unit arranged to retrieve a decryption algorithm from a second Near Field Communication (NFC) security label card according to the index; and
a decrypting unit arranged to decrypt the encrypted data packet according to the decryption algorithm to obtain the decrypted data packet.

26. The terminal according to claim 25, wherein
the encrypted data packet comprises an encrypted part and an unencrypted part;
the receiving unit is arranged to receive the index carried in the encrypted data packet along with the encrypted data packet.

27. The terminal according to claim 25, wherein
the unencrypted part also comprises an encryption label;
the terminal further comprises:
a parsing unit arranged to parse the unencrypted part of the received data packet to determine whether the encrypted data packet comprises the encryption label; and
a determining unit arranged to determine, when the encrypted data packet comprises the encryption label, that the data packet is the encrypted data packet; and
the retrieving unit arranged to retrieve, when it is determined that the received data packet is the encrypted data packet, the decryption algorithm from the second NFC security label card according to the index.

28. (canceled)

29. The terminal according to claim 25, wherein
the receiving unit is arranged to receive a negotiation data packet;
wherein the negotiation data packet is a data packet which is used by the source communication terminal to send the index to the target communication terminal.

30. The terminal according to claim 29, wherein
the receiving unit is arranged to receive, when the source communication terminal performs voice communication with the target communication terminal, the negotiation data packet through a short message communication link or a voice communication link.

31. (canceled)

32. (canceled)

33. (canceled)
